(19) United States
(12) Patent Application Publication
(10) Pub. No.: US 2008/0101346 A1
(43) Pub. Date: May 1, 2008

(54) Telephone system and its encryption processing method

(75) Inventor: Tsutomu Shibata, Hino-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/976,821

(22) Filed: Oct. 29, 2007

(30) Foreign Application Priority Data
Oct. 31, 2006 (JP) 2006-297161

(51) Int. Cl. H04L 12/66

(52) U.S. Cl. 370/352

(57) ABSTRACT

According to one embodiment, there is provided a telephone system, comprising a plurality of communication terminals configured to perform telephone communications, and a plurality of connecting devices which connect these communication terminals to a common packet communication network to establish communications among the communication terminals via the packet communication network. The plurality of the communication terminals each include notification processing units which notify presence or absence of encryption of media data, which is transmitted toward the packet communication network from their own terminals, at their own terminals to connecting devices right above their own terminals. And the plurality of connecting devices each include encryption processing units which encrypt the media data only when the facts of absence of the encryption at the communication terminals are notified from the communication terminals under their connecting devices.

### CROSS-REFERENCE TO RELATED APPLICATIONS

This application is based upon and claims the benefit of priority from Japanese Patent Application No. 2006-297161, filed Oct. 31, 2006, the entire contents of which are incorporated herein by reference.

### BACKGROUND

1. Field

One embodiment of the invention relates generally to a telephone system in which telephone terminals and software phones, etc., achieve voice communications via a communication network, such as an Internet protocol (IP) network. More specifically, one embodiment of the invention relates to the improvement of an encryption system in this kind of telephone system.

2. Description of the Related Art

The so-called voice over IP (VoIP), which makes voice communications by the use of the IP network, has mainstreamed to a telephone system, in recent years. As for such a kind of system, for example, a system capable of transmitting and receiving communication data through encryption in order to efficiently use a bandwidth is known (JP-A 2006-115507 (KOKAI)).

In the system of this type, telephone terminals are connected to the IP network via a virtual private network (VPN) device such as a router. The latest telephone terminal or VPN device frequently has an encryption function; however in the present situation, the system having the encryption function and that having no encryption function coexist. Therefore, some possibility that media data is encrypted over again is posed. That is, there is some possibility that a transmission packet encrypted by the telephone terminal is forced to be encrypted again by the VPN device before the packet is transmitted to the IP network. Though it is possible to reproduce voice through processing in a higher protocol layer for such a situation, the system causes inconvenience of consuming a communication resource uselessly, of deteriorating a quality of service (QoS), etc.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a preferred system view illustrating an embodiment of a telephone system regarding the invention system;

FIG. 2 is a view illustrating a security policy table for use in the system of FIG. 1;

FIG. 3 is a view illustrating a call connection processing sequence when encryption is performed among VPN devices;

FIG. 4 is a view schematically illustrating inter-terminal communications in the case of FIG. 3;

FIG. 5 is a view illustrating call connection processing sequence when encryption is performed among terminals; and

FIG. 6 is a view schematically illustrating inter-terminal communications in the case of FIG. 5.

### DETAILED DESCRIPTION

Various embodiments according to the invention will be described hereinafter with reference to the accompanying drawings. In general, according to one embodiment of the invention, there is provided a telephone system, comprising: a plurality of communication terminals configured to perform telephone communications; and a plurality of connecting devices which connect these communication terminals to a common packet communication network to establish communications among the communication terminals via the packet communication network. The plurality of the communication terminals each include notification processing units which notify presence or absence of encryption of media data, which is transmitted toward the packet communication network from their own terminals, at their own terminals to connecting devices right above their own terminals. And the plurality of connecting devices each include encryption processing units which encrypt the media data only when the facts of absence of the encryption at the communication terminals are notified from the communication terminals under their connecting devices.

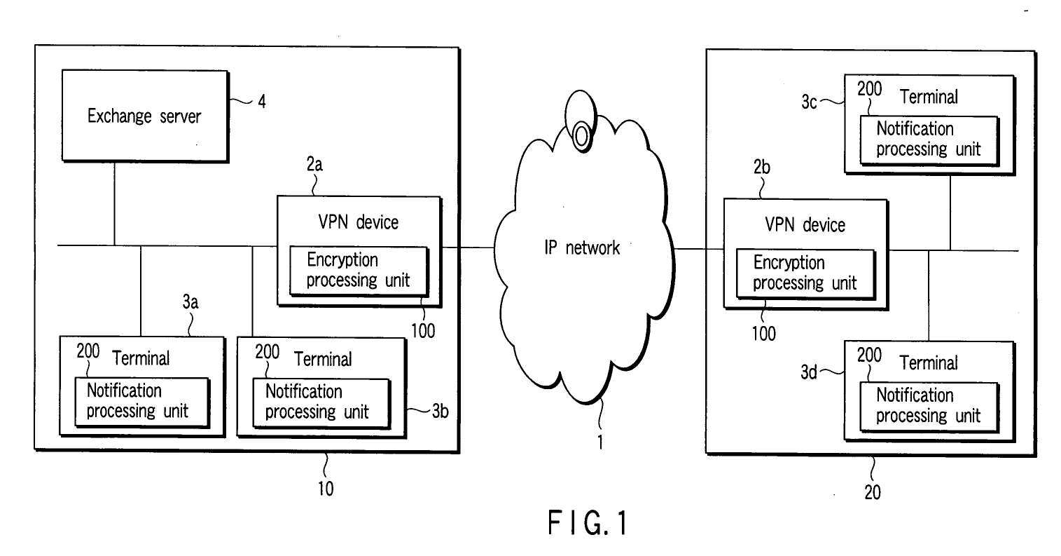

FIG. 1 shows a system view of an embodiment of a telephone system regarding the invention. The system connects between local networks 10 and 20 via an IP network 1 to establish mutual communications between each network 10 and 20.

The local network 10 includes terminals 3a and 3b, a VPN device 2a and an exchange server 4, and they are connected via a local area network (LAN) with one another. Among of them, the VPN device 2a is connected to the IP network 1 to mediate transmissions and receptions of media data and IP packets among the IP network 1, the terminals 3a, 3b, and exchange server 2a. That is the VPN device 2a connects the terminals 3a, 3b, and the exchange server 4 to the IP network 1.

The local network 20 includes terminals 3c, 3d and a VPN device 2b to be connected with one another via the LAN. Among of them, the VPN device 2b is connected to the IP network 1 to mediate transmissions and receptions of media data and IP packets among the IP network 1 and the terminals 3c, 3d. That is, the VPN device 2b connects the terminals 3c and 3d to the IP network 1.

Each of the terminals 3a-3d has telephone communication functions through a VoIP, for example, an IP telephone and an IP software phone. In addition, the terminals 3a-3d each have communication functions such as video communication exchange functions and text chatting functions sometimes. The software phone is a computer with software for calling installed therein.

The exchange server 4 receives transmission/calling/response/disconnection messages from the terminals 3a-3d, and conducts termination of connection destinations for callers and relaying of messages, etc., after determining the connection destinations. As to such a protocol for call connection processing, for example, a session initiation protocol (SIP) is used. After the establishment of the connection by the exchange server 4, the terminals 3a-3d directly transmits and receives packet data to and from opposite terminals, respectively, to communicate media streams such as voice data (peer to peer).

Some terminals 3a-3d have functions to encrypt the packets (media data) to be transmitted to the IP network 1 in order to prevent, for instance, personal information from being flowed out and tapped. In the embodiment, it is supposed that the terminals 3a and 3d support the encryption function, and the terminals 3b and 3c do not support the function.

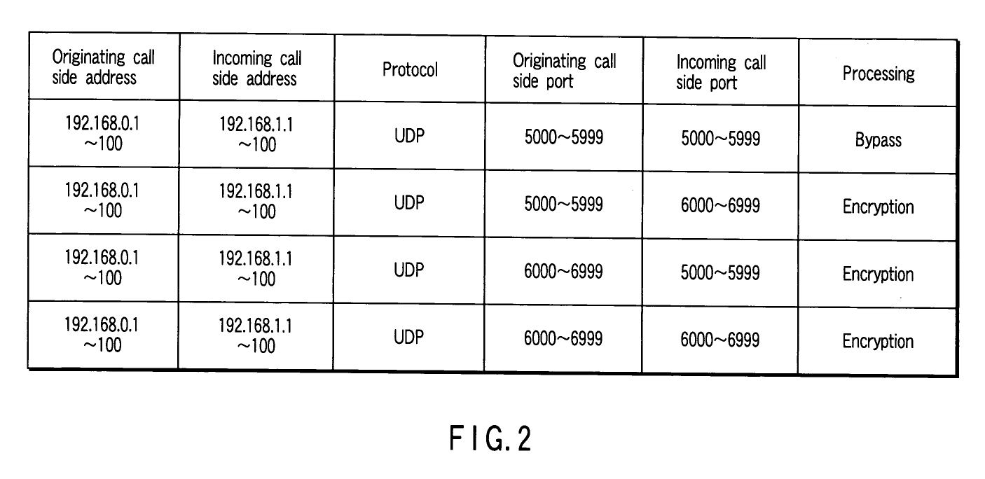

The terminals 3a-3d have notification processing unit 200 each. The notification processing unit 200 notifies whether the packets are encrypted or not to the VPN device located right above by, for example, transmitting encryption discrimination information. In the embodiment, the telephone system uses port numbers as the encryption discrimination information. In addition, the VPN devices 2a and 2b comprises an encryption processing unit 100 so as to achieve an encryption function similar to the aforementioned function. The VPN devices 2a-2b each have security policy tables shown in FIG. 2.

Plainly speaking, the table depicted in FIG. 2 is one to associate correspondence relations among outgoing call side port numbers and incoming call side port numbers with the presence/absence of the encryption. The table describes outgoing call side IP addresses, incoming call side IP addresses, protocols to be used (UDPs), etc., other than this. The security policy table is recommended in the standard of IPsec, etc. The tables are also stored in the terminals 3a-3d each, and in the embodiment, each terminal 3a-3d varies its port number in accordance with presence or absence of its own encryption function.

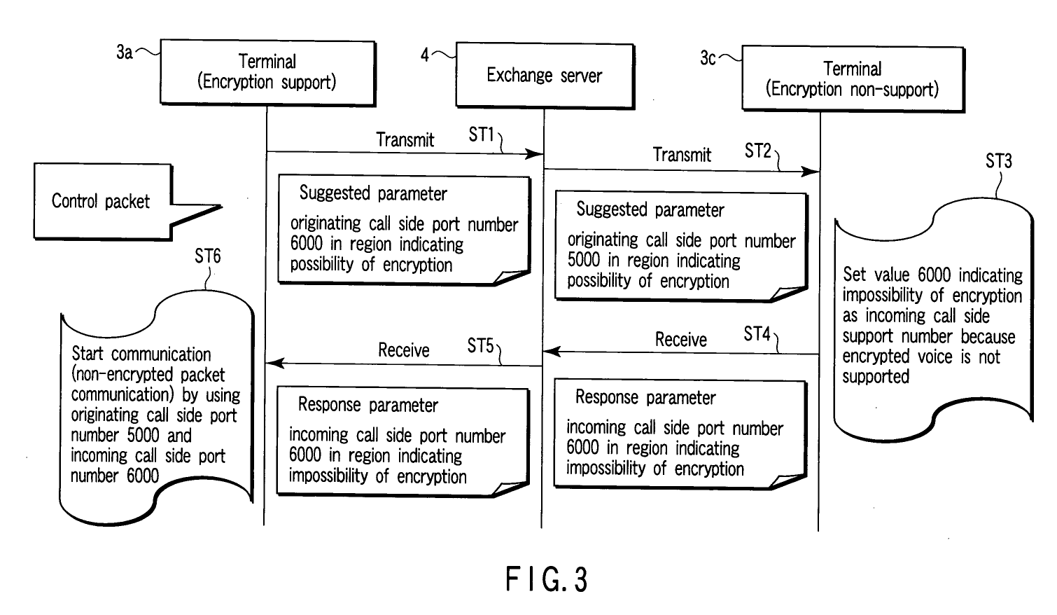

FIG. 3 is a view showing a call connection processing sequence when the encryption is performed between the VPN devices. In FIG. 3, when the user of the terminal 3a conducts an outgoing call operation in order to connect to the terminal 3c, the outgoing message is transmitted from the terminal 3a to the exchange server 4 (step ST1). The outgoing message includes a suggesting parameter including an outgoing call side port number to be used for packet communications. The suggesting parameter is included in, for example, an INVITE message of the SIP. Here, as for the outgoing call side port number, “5000” is used that is an example of a value within a value indicating the possibility of an encrypted communication.

The exchange server 4 determines a connection destination (terminal 3c) from a destination parameter included in the received outgoing message to transmit an outgoing message toward the terminal 3c (step ST2). The terminal 3c which has received the outgoing message determines whether or not its own terminal can encrypt the outgoing message. In the embodiment, it is determined that its own terminal cannot encrypt the outgoing message, and the terminal 3c sets a value 6000 indicating the impossibility of the encryption as the incoming call side port number (step ST3).

Next, the terminal 3c returns an incoming message including a response parameter including an incoming call side port number to be used for the packet communications (step ST4). The response parameter includes “6000,” which is the incoming call side number. The exchange server 4 which has received the incoming message relays it to the terminal 3a (step ST5). After the arrival of the incoming message at the terminal 3a, the terminals 3a and 3c start communications through non-encrypted packets by using the outgoing call side port number 5000 and the incoming call side port number 6000 (step ST6).

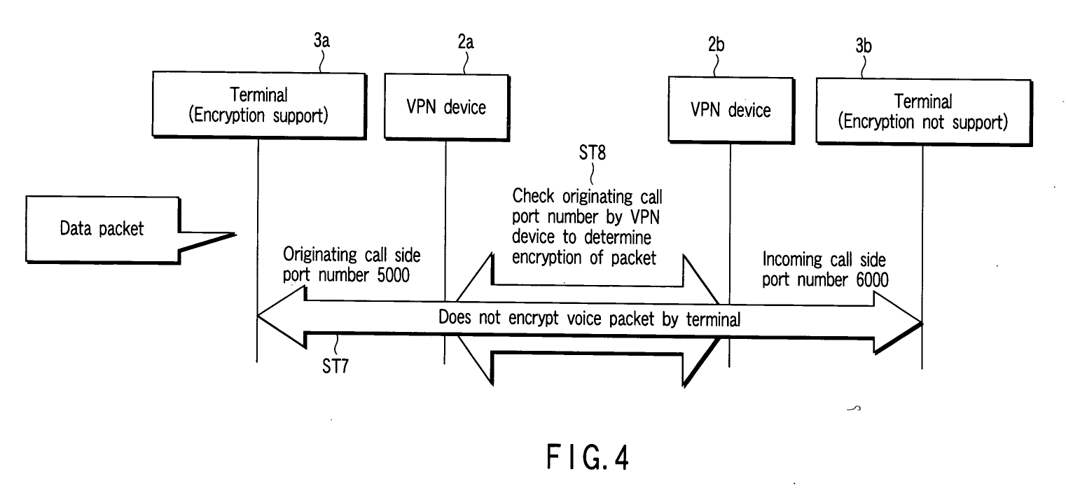

FIG. 4 schematically depicts inter-terminal communications in the case of FIG. 3. In FIG. 4, the terminals 3a and 3c communicate with each other through the non-encrypted packets (step ST7). The VPN devices 2a and 2b monitor packet communications between the terminals 3a and 3c to recognize the outgoing call side port number 5000 and the incoming call side port number 6000. From the result and the content of the security policy table the VPN devices 2a and 2b determine that it is necessary for encryption for this connection between the terminals 3a and 3c. As a result, the encryption of packets is implemented between the VPN devices 2a and 2b.

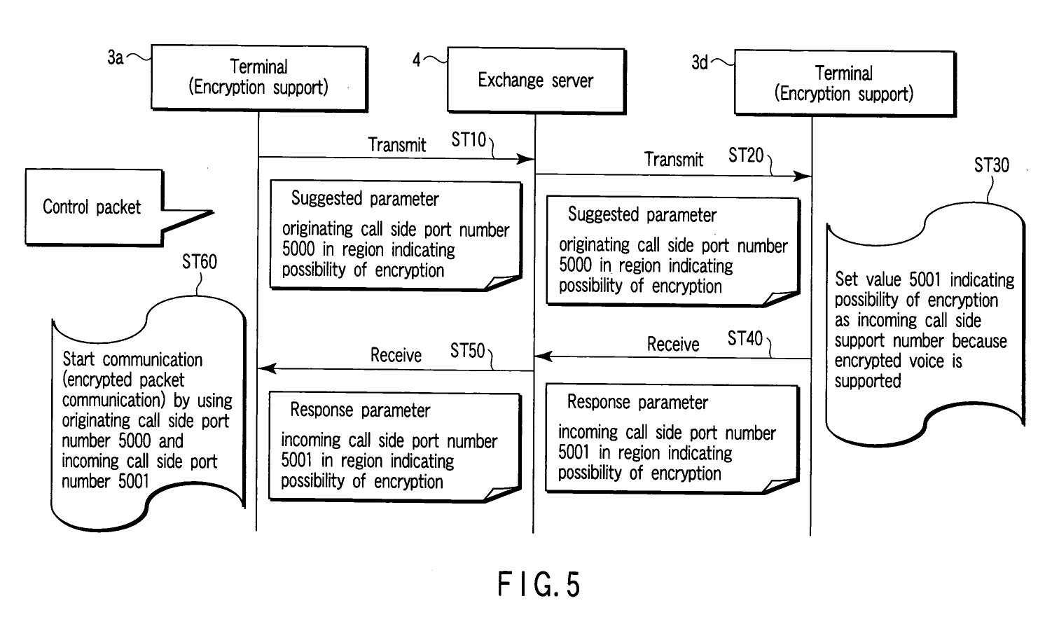

FIG. 5 is a view showing a call connection processing sequence when the encryption is carried out among the terminals. In FIG. 5, when the user of the terminal 3a conducts an outgoing operation so as to connect the terminal 3a to the terminal 3d, the outgoing message is transmitted from the terminal 3a to the exchange server 4 (step ST10). The transmitted message includes 5000 as the outgoing call side port number.

The exchange server 4 determines the connection destination (terminal 3d) on the basis of the destination parameter included in the received outgoing message to transmit the outgoing message toward the terminal 3d (step ST20). The terminal 3d which has received the outgoing message determines the possibility of the encryption by its own terminal. In the embodiment, it is determined that its own terminal can encrypt the outgoing message, and the terminal 3d sets a value 5001 indicating the possibility of the encryption as the incoming call side port number (step ST30).

Next, the terminal 3d returns the incoming message including the response parameter including the incoming call side port number to be used for the packet communications (step ST40). The response parameter includes 5001, which is the incoming call side port number. The exchange server 4 which has received the incoming message relays the incoming message to the terminal 3a (step ST50). After the arrival of the incoming message at the terminal 3a, the terminals 3a and 3d start communications through the encrypted packets by the use of the outgoing call side port number 5000 and the incoming call side port number 5001 (step ST60).

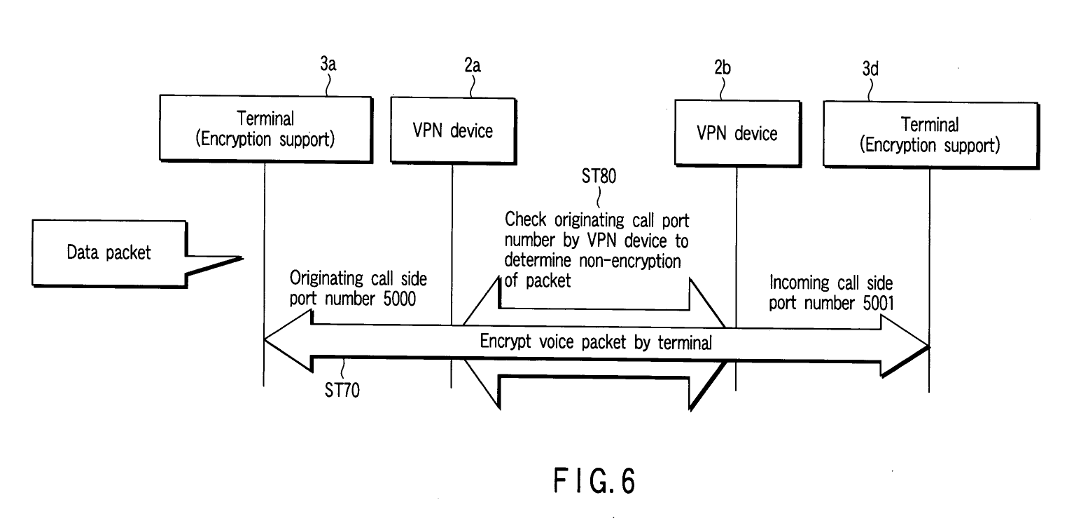

FIG. 6 schematically illustrates inter-terminal communications in the case of FIG. 5. In FIG. 6, the terminals 3a and 3d communicates with each other through the encrypted packets (step ST70). The VPN devices 2a and 2b monitors the packet communications between the terminals 3a and 3d to recognize the outgoing call side port number 5000 and the incoming call side port number 5001. Depending on the recognition result and the content of the security policy table, the VPN devices 2a and 2b determine that they do not encrypt the connection between the terminals 3a and 3d. Depending on the recognition result, the packets are not encrypted between the VPN devices 2a and 2b.

As mentioned above, in the embodiment, the terminals 3a-3d vary the outgoing call side port numbers and the incoming call side port numbers to implement the call connection processing sequence in response to the presence or absence of the encryption function of their own terminals. The relations among the presence or absence and the port numbers are associated with the prepared security policy table. The VPN devices 2a and 2b check the port numbers among terminals which are connected with the VPN devices 2a and 2b, and determine to encrypt or not to encrypt by its own VPN device in accordance with the check result and the content of the table.

Since the determination is performed as mentioned above, it becomes possible for the VPN devices 2a and 2b not to encrypt blindly and to encrypt if necessary in response to the presence or absence of the encryption at the terminal devices. The telephone system thereby becomes able to prevent wasted consumption of a resource in which the VPN device further encrypts the media data after the terminal encrypts it, and to effectively utilize the encrypted resource of the VPN device. Moreover, the system becomes able to effectively use facilities and to reduce the cost. In VoIP communication, the user becomes able to easily determine the security level for each communication, and the convenience of the system is significantly improved. Therefore, a telephone system and its encryption processing method capable of preventing unnecessary encryption processing can be provided.

The invention is not limited to the aforementioned embodiments as they are. For example, the encryption discrimination information is not limited to the outgoing/incoming port numbers, and the user can use the information defined independently. Not only the media data but also control information, such as an outgoing message and a response message, can be treated as a target of the encryption.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone system, comprising:
a plurality of communication terminals configured to perform telephone communications; and
a plurality of connecting devices which connect these communication terminals to a common packet communication network to establish communications among the communication terminals via the packet communication network, wherein
the plurality of the communication terminals each include notification processing units which notify presence or absence of encryption of media data, which is transmitted toward the packet communication network from their own terminals, at their own terminals to connecting devices right above their own terminals, and
the plurality of connecting devices each include encryption processing units which encrypt the media data only when the facts of absence of the encryption at the communication terminals are notified from the communication terminals under their connecting devices.

2. The telephone system according to claim 1, wherein
the notification processing units notify presence or absence of the encryption by adding encryption discrimination information to the media data.

3. The telephone system according to claim 2, wherein
the encryption discrimination information includes the port number of the communication terminal and the port number of the communication terminal of communication partner of the communication terminal.

4. The telephone system according to claim 1, wherein
the plurality of communication terminals and the plurality of the connecting devices each include security policy tables which determine presence and absence by correspondence relations among originating call side port numbers and incoming call port numbers,
the plurality of communication terminals which vary at least either the originating call side port numbers or the incoming call side port numbers along with the security policy tables to notify presence or absence of the encryption, and
the plurality of connecting devices refer to the security policy tables on the basis of correspondence relations among the outgoing call side port numbers and the incoming call side port numbers included in notification received from communication terminals under the connecting devices to determine encryption of the media data at their own device.

5. An encryption processing method which includes a plurality of communication terminals configured to make telephone communications, and a plurality of connecting devices which connect these communication terminals to a common packet communication network to establish communications among the communication terminals via the packet communication network, wherein
the plurality of communication terminals notify presence or absence of encryption of media data, which is transmitted toward the packet communication network from their own terminals, at their own terminals to connecting devices right above their own terminals, and
the plurality of connecting devices encrypt the media data only when the facts of absence of the encryption at the communication terminals are notified from the communication terminal under their connecting terminals.

6. The encryption processing method according to claim 5, wherein the plurality of communication terminals notify presence or absence of the encryption by adding encryption discrimination information indicating presence or absence of the encryption to the media data.

7. The encryption processing method according to claim 6, wherein the encryption discrimination information includes the port number of the communication terminal and the port number of the communication terminal of communication partner of the communication terminal.

8. The encryption processing method according to claim 5, wherein
the plurality of communication terminals and the plurality of connecting devices each have security policy tables to determine presence or absence of the encryption by correspondence relations among originating call side port numbers and incoming call side port numbers,
the plurality of communication terminals vary at least either the originating call side port numbers or the incoming call side port numbers along with the security policy tables to notify presence or absence of the encryption; and
the plurality of connecting devices refer to the security policy tables on the basis of the originating call side port numbers and the incoming call side port numbers included in information received from communication terminals under the connecting devices to determine encryption of the media data at their own devices.
